(19) United States
(12) Patent Application Publication
(10) Pub. No.: US 2008/0263245 A1
(43) Pub. Date: Oct. 23, 2008

(54) OTG DEVICE FOR MULTI-DIRECTIONALLY TRANSMITTING GPS DATA AND CONTROLLING METHOD OF SAME

(75) Inventor: Hsiang-chi Hsieh, Sindian City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/776,408

(22) Filed: Jul. 11, 2007

(30) Foreign Application Priority Data
Apr. 20, 2007 (TW) 096114074

(51) Int. Cl. G06F 13/42

(52) U.S. Cl. 710/106

(57) ABSTRACT

The present invention provides an OTG device for multi-directionally transmitting GPS data and a controlling method of the same. The OTG device is capable of automatically being switched as a master or slave devices based on a type of an external device connected thereto, thereby preventing a conflict between the OTG device and other external devices. Therefore, the GPS data received by a GPS module of the OTG device can easily be transmitted to the external device. Furthermore, the OTG device and the associated controlling method can be utilized in a multimedia device, such that the multimedia device is capable of GPS positioning, and multi-directionally transmitting GPS data and image data to be stored.

### BACKGROUND OF THE INVENTION

1. Field of the Invention

The present invention relates to a universal serial bus On-The-Go (OTG) device for multi-directionally transmitting Global Positioning System (GPS) data and controlling method of the same, and more particularly, to an OTG device for transmitting GPS data to various types of universal serial bus (USB) devices, and controlling method of the same.

2. Description of Prior Art

The Global Positioning System (GPS) device can only instantly display or utilize a coordinate data of present location, within the original GPS device. However, for outputting the coordinate data, a complicated setup program is required to transfer the coordinate data to anther device. Therefore, it is considerably inconvenient for a conventional GPS device to transfer the coordinate data to other external devices; conversely, the other external devices may also utilize the coordinate data of the conventional GPS device.

In addition, most of well-known universal serial bus On-The-Go (OTG) devices can only transmit the data saved in hard disk or memory card to a host device in one way. If the data saved in hard disk or memory card is required to be output to other hard disk or memory card, then it must first be transferred to a host device, therein the data desired is output to other hard disk or memory card then to be saved. In such case, to transfer data utilizes more time and cost, which brings some incontinences to users.

Therefore, it is necessary to provide an improved OTG device for multi-directionally transmitting GPS data, for the GPS coordinate data to be easily transmitted to other external devices for use.

### SUMMARY OF THE INVENTION

It is therefore an object of the present invention is to provide an OTG device for multi-directionally transmitting GPS data and a controlling method of the same, for transmitting GPS data to various types of USB devices.

In addition, the present invention also provides an OTG device capable of being integrated with a multimedia device for multi-directionally transmitting GPS data and a controlling method of the same, which enables the multi-media device to have the functions of GPS positioning and multi-directionally transmitting GPS data or image data.

Briefly summarized, the claimed invention provides an OTG device for multi-directionally transmitting GPS data. The OTG device comprises an antenna, a GPS module, a USB OTG controller, a storage device, and a USB interface. The GPS module decodes a GPS signal receiver by the antenna as a coordinate data. Then, the GPS module transmits the coordinate data to the USB OTG controller via a serial interface. The storage device, e.g. a flash card, a memory card, a hard disk, is used for storing the coordinate data. The USB OTG controller transmits the text file stored in the storage device to the external device or transmits the data stored in the external device to the storage device in response to a controlling signal, when the OTG device is electrically connecting to the external device. The USB OTG controller automatically sets the OTG device as a master device or a slave device based on a type of the external device electrically connected to the OTG device. For example, the OTG device is set as a slave device when the OTG device is electrically connecting to a host device; conversely, the OTG device is set as a master device when the OTG device is electrically connecting to a USB device. If the OTG device comprises more than two kinds of storage devices, for example, the flash memory and/or the memory card and/or the hard disk, the data saved in various storage devices may be inter-transmitted to each other via the USB OTG controller.

The OTG device according to the present invention may also be applied to a multimedia device, such that the multi-media device provided with the same, is capable of taking GPS positioning and multi-directionally transmitting GPS data or image data.

The method of controlling an OTG device for multi-directionally transmitting GPS data comprises the steps of:
Step 1: receiving a GPS signal;
Step 2: decoding the GPS signal to generate a coordinate data;
Step 3: converting the coordinate data into a text file, and storing the text file in a storage device;
Step 4: determining an external device electrically connecting to the OTG device is a master device or a slave device with the USB OTG controller;
Step 5: setting the OTG device as a slave device if the external device is a master device;
Step 6: setting the OTG device as a master device if the external device is a slave device;
Step 7: accessing and inter-transmitting data between the master device and the OTG device; and
Step 8: accessing and inter-transmitting data between the slave device and the OTG device.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 shows a functional block diagram of an OTG device capable of multi-directionally transmitting GPS data to access the data of the host device according to a first embodiment of the present invention.

FIG. 2 shows a functional block diagram of an OTG device capable of multi-directionally transmitting GPS data to access the data of the host device according to a second embodiment of the present invention.

FIG. 3 shows a functional block diagram of an OTG device for multi-directionally transmitting GPS data accessing the data of the host device.

FIG. 4 shows a flow chart of the steps of controlling method of the OTG device for multi-directionally transmitting GPS data according to the present invention.

### DETAILED DESCRIPTION OF THE INVENTION

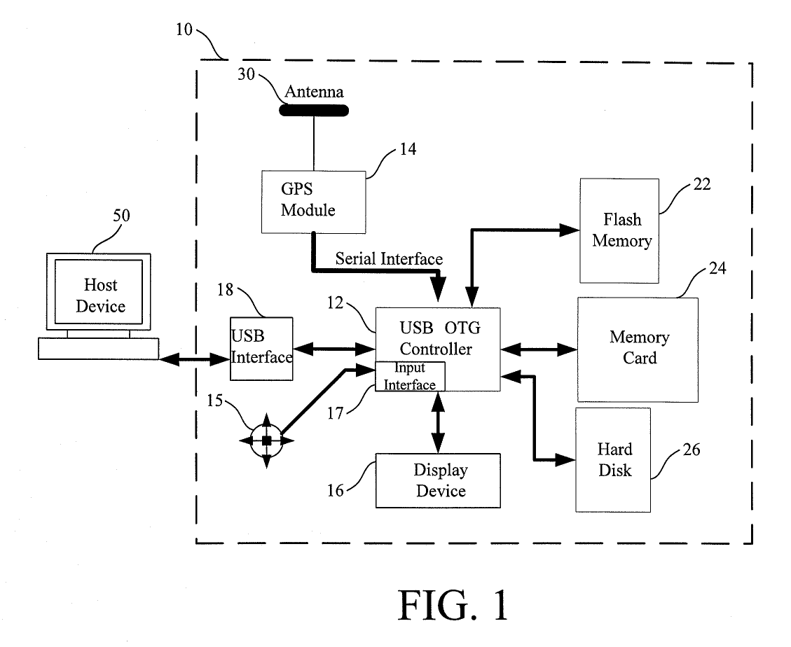

Please refer to FIG. 1, which shows a functional block diagram of an OTG device 10 capable of multi-directionally transmitting GPS data to access the data of the host device 50 according to a first embodiment of the present invention. The OTG device 10 includes a USB OTG controller 12, a GPS module 14, a display device 16, a USB interface 18 and an antenna 30. The antenna 30 may receive the GPS positioning signal, which is then decoded into a coordinate data by the GPS module 14. The GPS module 14 transmits the coordinate data to the USB OTG controller 12, via a serial interface. In addition, the OTG device 10 further comprises a flash memory 22, a memory card 24 or a hard disk 26. The USB OTG controller 12 converts the coordinate data into a text file, and then the data in text file is saved in any one of the storage devices, namely, the flash memory 22, the memory card 24 or the hard disk 26, according to user's requirement. The USB OTG controller 12, electrically connected to a host device 50 via a USB interface 18, may transmit the coordinate data stored in the flash memory 22, the memory card 24 or the hard disk 26, to the host device 50, or, transmit the data saved in the host device 50, to the flash memory 22, the memory card 24 or the hard disk 26, for multi-directionally transmitting GPS data and the copies thereof. It should be noted that, if the host device 50 externally connected to the OTG device 10 is a master device, the USB OTG controller 12 may automatically sets as a slave device for the OTG device 10.

The host device 50 may be an external device in accordance with USB specification, such as a desktop computer, a notebook computer, a cellular phone and a personal digital assistant, and the like, which is electrically connected to the OTG device via a USB interface. On the other hand, one or more of storage devices from the flash memory 22, the memory card 24 and the hard disk 26, may be configured in the OTG device 10. The memory card 24 may be a flash memory card of any specification, such as secure digital (SD), Mini Secure digital (Mini SD), Multimedia card (MMC), Compact Flash (CF), Memory Stick (MS), Smart media (SM) memory cards. Furthermore, when the OTG device 10 comprises more than two kinds of storage devices, for example, the flash memory 22 and/or the memory card 24 and/or the hard disk 26, the data saved in various storage devices may be inter-transmitted to each other via the USB OTG controller 12.

In addition, the OTG device 10 comprises an input device 15, for a user to manually input a desired controlling signal. The USB OTG controller 12 includes an input interface 17 capable of converting the controlling signal into a controlling instruction, to control the USB OTG controller 12. That is, the USB OTG controller 12 may transmit the coordinate data saved in the flash memory 22, the memory card 24 or the hard disk 26, to the host device 50, or, may transmit the data saved in the host device 50 to the flash memory 22, the memory card 24, or the hard disk 26, in response to different controlling instructions. In this embodiment of the present invention, the input device 15 may be a multi-directional button, a toggle button and so on, and the input interface 17 may be an analog-to-digital converter (ADC). The USB OTG controller 12 may, transmit the coordinate data or operating information to the display device 16, e.g. a liquid crystal display, for the user to know the present coordinate data or operating condition.

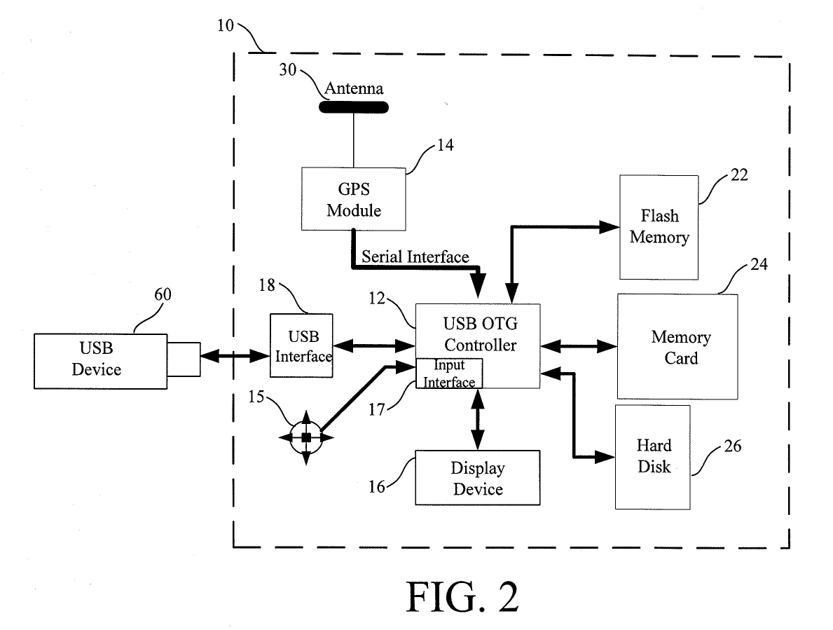

Please refer to FIG. 2, which shows a functional block diagram of an OTG device 10 capable of multi-directionally transmitting GPS data to access the data of the host device 60 according to a second embodiment of the present invention. The USB OTG controller 12 may, when the OTG device 10 is externally connected to the USB device 60, automatically setup a master device for the OTG device 10, and then the USB device 60 acts as a slave device. Consequently, similar with the description according to FIG. 1, the input device 15 manually generates a desired controlling signal according to user's requirement. Then, the controlling signal, after being transmitted to the input interface 17 via the USB OTG controller 12, is converted into a controlling instruction, to control the USB OTG controller 12. That is, the USB OTG controller 12 may, transmit the coordinate data saved in the flash memory 22, the memory card 24 or the hard disk 26, to the host device 60, or, transmit the data saved in the host device 60, to the flash memory 22, the memory card 24 or the hard disk 26, for multi-directionally transmitting GPS data and the copies thereof. The USB device 60 may be an external device in accordance with USB specification, such as a USB portable drive, a USB interface hard disk or a memory card reader, etc.

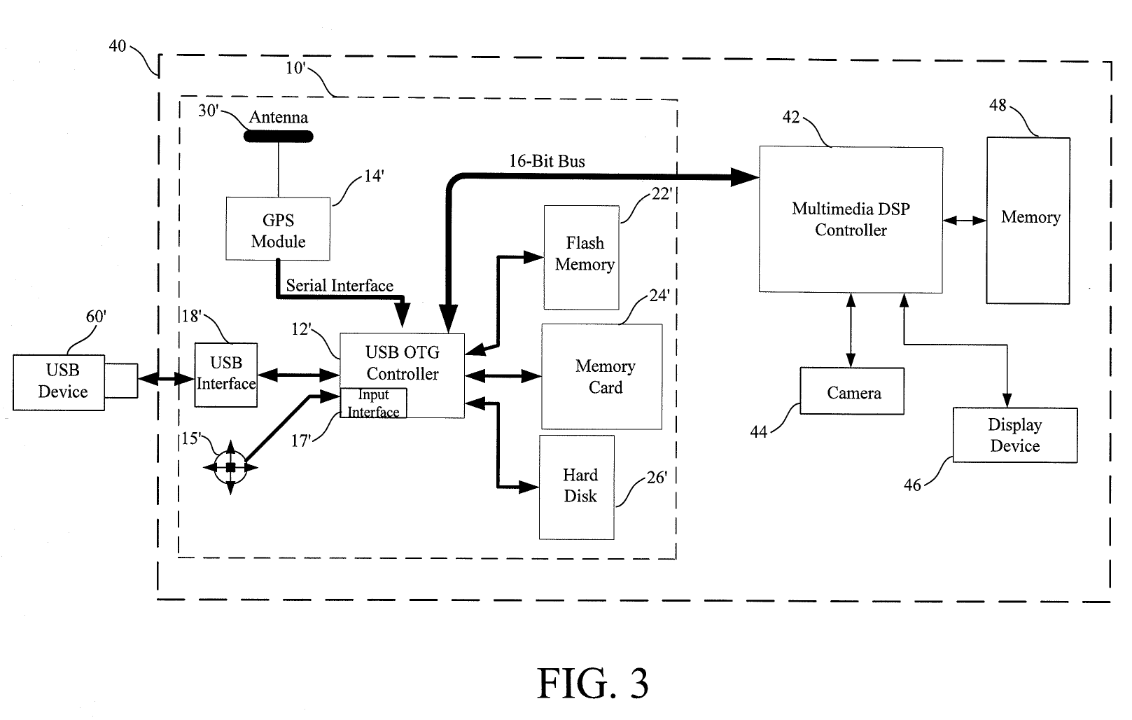

Please refer to FIG. 3, which shows a functional block diagram of an OTG device 10′ for multi-directionally transmitting GPS data accessing the data of the host device 40 according to the present invention. The multimedia device 40 includes a multimedia digital signal processing (DSP) controller 42, a camera 44, a display device 46 and a memory 48. The multimedia DSP controller 42 is used to control the camera 44, the display device 46 and the memory 48, so as to save or display images. The camera 44 may be a charge coupled device (CCD) or a complementary metal-oxide-semiconductor (CMOS) device, and the display device 46 may be a liquid crystal display or other display device. The USB OTG controller 12′ may, be electrically connected to the multimedia DSP controller 42 via a 16-bit bus, or transmit data to the multimedia DSP controller 42. In such case, the multimedia device 40 may, with the functions of multi-directionally transmitting data via the OTG device 10′ and GPS positioning, save the image data picked by the camera 44, in the flash memory 22′, the memory card 24′ or the hard disk 26′, and also utilize the coordinate data received by the GPS module 14′. For instance, the location of camera may be positioned when attaching the coordinate data to an image data. When the OTG device 10′ is electrically connected to an external device, the USB OTG controller 12′ may, based on a desired controlling signal according to user's requirement, transmit the data saved in storage device or memory to the external device, via the USB interface 18′, or, transmit the data in external device to the storage device or the memory 48 then save it.

In addition, the multimedia device 40 provided with the OTG device 10′ may further be electrically connected to a USB device 60′, such that the multimedia device 40 becomes a master device and the USB device 60′ and the OTG device 10′ become slave devices. Thereby, the input device 15′ manually generates a desired controlling signal according to user's requirement. Then, the controlling signal, after being transmitted to the input interface 17′, via the USB OTG controller 12′, is converted into a controlling instruction, for controlling the multimedia DSP controller 42 of the multimedia device 40. That is, the multimedia DSP controller 42 may, transmit the coordinate data saved in the flash memory 22′, the memory card 24′ or the hard disk 26′, to the host device 60′, or transmit the data saved in the host device 60′, to the flash memory 22′, the memory card 24′ or the hard disk 26′, for multi-directionally transmitting GPS data and the copies thereof. The USB device 60′ may be an external device in accordance with USB specification, such as a USB portable drive, a USB interface hard disk or a memory card reader, etc.; and the multimedia device 40 may be a digital camera, a digital video recorder, a mobile phone and a personal digital assistant, etc.

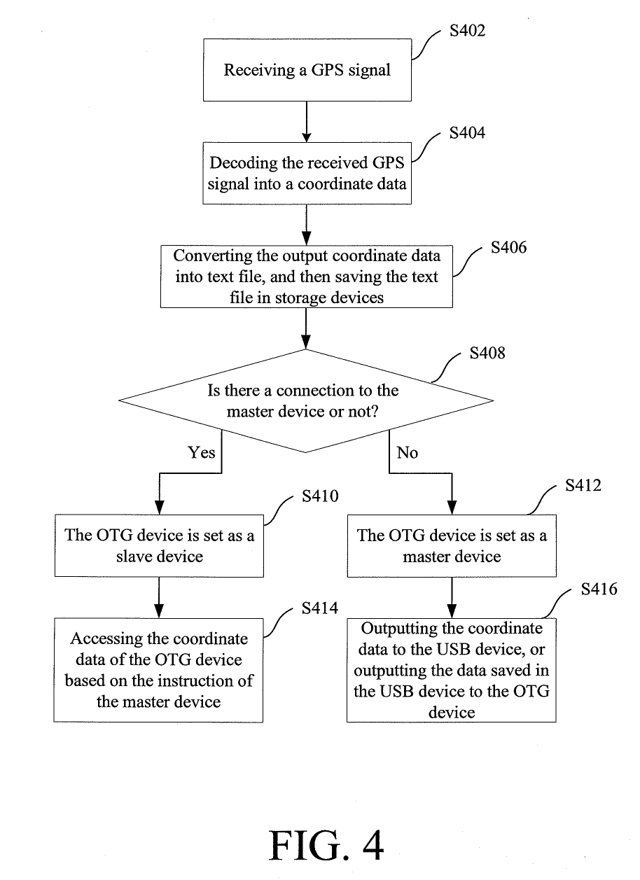

FIG. 4 shows a flow chart of the steps of controlling method of the OTG device for multi-directionally transmitting GPS data according to the present invention. Incorporating with the OTG device for multi-directionally transmitting GPS data depicted in FIG. 1, the method comprises the following steps:
S402: The antenna 30 receives then transmits a GPS signal to the GPS module 14.
S404: The GPS module 14 decodes the GPS signal in S402 to generate a coordinate data, which is then transmitted to the USB OTG controller 12.
S406: The USB OTG controller 12 converts the coordinate data in S404 into a text file, which is then saved in storage devices such as the flash memory 22, the memory card 24 or the hard disk 26.
S408: When the OTG device 10 is electrically connected to at least one external device, the USB OTG controller 12, based on the controlling signal according to user's requirement, may output the coordinate data saved in storage devices to the external device, or transmit the data saved in the external device to the storage devices then to save it. The controlling signal generated by the input device 15 according to user's requirement, after being transmitted to the input interface 17, via the USB OTG controller 12, is converted into a controlling instruction, to control the OTG device 10. The USB OTG controller 12 determines whether the external device electrically connected to the OTG device is a master device. Then, based on the result, that is, the external device is as a mater device or a slave device, the S410 or the S412 will be executed correspondingly.
S410: The USB OTG controller 12 automatically sets the OTG device 10 as a salve device, and then executes the S414.
S412: The USB OTG controller 12 automatically sets the OTG device 10 as a master device, and then executes the S416.
S414: The USB OTG controller 12, based on the instruction from the master device, accesses the coordinate data or other data saved in storage device of the OTG device 10. Meanwhile, the USB OTG controller 12 also displays the coordinate data or the operating condition of the OTG device 10, via the display device 16. In such case, the OTG device 10 is used as an external storage device of the master device.
S416: The USB OTG controller 12 outputs the coordinate data or other data to the slave device, or outputs the data saved in the slave device to the OTG device 10. Meanwhile, the coordinate data or the operating condition of the OTG device 10 is displayed, via the display device 16. In such case, the slave device is used as an external storage device of the OTG device 10.

In contrast to the prior art, the OTG device for multi-directionally transmitting GPS data and the controlling method of the same according to the present invention may, based on the type of other external device connected to the OTG device thereof, such as host device or USB device, automatically switch the OTG device to a master or a slave device. As a result, the conflict between the OTG device and the external device may be avoided, thereby effectively transmitting the coordinate data to other external devices for use. On the other hand, the OTG device for multi-directionally transmitting GPS data and the controlling method of the same according to the present invention, may be integrated with a multimedia device, such that the multimedia device has the functions of GPS positioning and multi-directionally transmitting the saved GPS data or image data.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An OTG device for multi-directionally transmitting GPS data, comprising:
an antenna for receiving a GPS signal;
a GPS module for decoding the GPS signal as coordinate data;
a USB OTG controller for converting the coordinate data into a text file;
a storage device for storing the text file; and
a USB interface for being electrically connected with an external device using USB specification.

2. The OTG device of claim 1, wherein the USB OTG controller transmits the text file stored in the storage device to the external device or transmits the data stored in the external device to the storage device in response to a controlling signal, when the OTG device is electrically connecting to the external device.

3. The OTG device of claim 2, further comprising:
an input device for generating the controlling signal inputted by a user;
an input interface for converting the controlling signal into a controlling instruction, to control the USB OTG controller; and
a display device for displaying the coordinate data or an operating condition of the OTG device.

4. The OTG device of claim 3, wherein the display device is a liquid crystal display.

5. The OTG device of claim 3, wherein the input device is a multi-directional button and a toggle button.

6. The OTG device of claim 3, wherein the input interface is an analog-to-digital converter.

7. The OTG device of claim 1, wherein the USB OTG controller automatically sets the OTG device as a master device or a slave device based on a type of the external device electrically connected to the OTG device.

8. The OTG device of claim 1, wherein the storage device is a flash memory, a memory card, or a hard disk.

9. The OTG device of claim 1, wherein the GPS module transmits the coordinate data to the USB OTG controller via a serial interface.

10. A method of controlling an OTG device for multi-directionally transmitting GPS data, comprising:
receiving a GPS signal with an antenna and transmitting the GPS signal to a GPS module;
decoding the GPS signal with GPS module to generate a coordinate data, and transmitting the coordinate data to a USB OTG controller; and
converting the coordinate data with the USB OTG controller into a text file, and storing the text file in a storage device.

11. The method of claim 10, further comprising:
transmitting the text file stored in the storage device to the external device or transmitting the data stored in the external device to the storage device with the USB OTG controller, in response to a controlling signal, when the OTG device is electrically connecting to an external device.

12. The method of claim 11, further comprising:
determining the external device electrically connected to the OTG device is a master device or a slave device by using the USB OTG controller;
automatically setting the OTG device as a slave device to transmit data if the external device is a master device; and
automatically setting the OTG device as a master device to transmit data if the external device is a slave device.

13. The method of claim 11, further comprising:
generating the controlling signal with an input device inputted by a user;
converting the controlling signal into a controlling instruction for the USB OTG controller with an input interface, to control the OTG device; and
displaying the coordinate data or an operating condition of the OTG device.

14. The method of claim 10, wherein the storage device is a flash memory, a memory card, or a hard disk.

15. A multimedia device, comprising:
an OTG device for multi-directionally transmitting GPS data, comprising:
an antenna for receiving a GPS signal;
a GPS module for decoding the GPS signal as coordinate data;
a USB OTG controller for converting the coordinate data into a text file;
a storage device for storing the text file; and
a USB interface for being electrically connected with an external device using USB specification;
a camera for capturing an image;
a display device for displaying the image captured by the camera, or an operating condition of the multimedia device;
a memory for storing the image captured by the camera;
a multimedia DSP controller, electrically connected to the USB OTG controller, for controlling the camera, the display device, and the memory, and for transmitting the coordinate data and the image.

16. The multimedia device of claim 15, wherein the USB OTG controller transmits the text file stored in the storage device to the external device or transmits the data stored in the external device to the storage device in response to a controlling signal, when the OTG device is electrically connecting to the external device.

17. The multimedia device of claim 16, wherein the USB OTG controller automatically sets the OTG device as a master device or a slave device based on a type of the external device electrically connected to the OTG device.

18. The multimedia device of claim 15, further comprising:
an input device for generating the controlling signal inputted by a user; and
an input interface for converting the controlling signal into a controlling instruction to control the USB OTG controller.

19. The multimedia device of claim 18, wherein the input device is a multi-directional button and a toggle button.

20. The multimedia device of claim 18, wherein the input interface is an analog-to-digital converter.

21. The multimedia device of claim 15, wherein the display device is a liquid crystal display.

22. The multimedia device of claim 15, wherein the storage device is a flash memory, a memory card, or a hard disk.

23. The multimedia device of claim 15, wherein the GPS module transmits the coordinate data to the USB OTG controller via a serial interface.

24. The multimedia device of claim 15, wherein the USB OTG controller electrically connects and transmits data to the multimedia DSP controller via a 16-bit bus.
